(19) United States
(12) Patent Application Publication
(10) Pub. No.: US 2018/0170020 A1
(43) Pub. Date: Jun. 21, 2018

(54) BIODEGRADABLE LAMINATE FILM STRUCTURE

(71) Applicant: Layfield Group Ltd., Edmonton (CA)

(72) Inventors: Mark Rose, White Rock (CA); Richard Synnott, Blaine, WA (US)

(73) Assignee: Layfield Group Ltd., Edmonton (CA)

(21) Appl. No.: 15/844,396

(22) Filed: Dec. 15, 2017

Related U.S. Application Data
(60) Provisional application No. 62/435,584, filed on Dec. 16, 2016.

(51) Int. Cl. B32B 27/18; B32B 27/08; B32B 27/32

(52) U.S. Cl. CPC B32B 27/18; B32B 27/08; B32B 2307/7244; B32B 2307/7163; B32B 27/32

(57) ABSTRACT

A biodegradable, flexible laminate film is provided, which is made up of a first substrate and a second substrate laminated to the first substrate. Each substrate is made from a polymer-based material that is biodegradable in an anaerobic, microbial environment over a period of more than 100 years and an additive that reduces the period of biodegradability of the polymer-based material to less than 40 years.

### TECHNICAL FIELD

This relates to a biodegradable laminate film structure that may be used in packaging applications.

### BACKGROUND

Packaging is used with most commercial products to unitize and protect the packaged product. In order to maintain the durability, flexibility, and strength of the packaging while minimizing costs, packaging is generally made from polymer-based materials, such as polyethylene, polypropylene, polyester, etc. Unfortunately, despite the many advantages of these materials, most polymer-based packaging is not readily biodegradable, and may take hundreds of years to break down.

### SUMMARY

According to an aspect, there is provided a biodegradable, flexible laminate film, comprising a first substrate and a second substrate laminated to the first substrate, wherein each substrate comprises a polymer-based material that is biodegradable in an anaerobic, microbial environment over a period of more than 100 years and an additive that reduces the period of biodegradability of the polymer-based material to less than 40 years.

According to other aspects, the polymer-based material may be derived from fossil fuels or biomass material, the biodegradable laminate structure may further comprise one or more additional substrates laminated to the first or the second substrate, the second substrate may be a different material than the first substrate, adjacent substrates may be connected by an adhesive or by an extrusion lamination process, the polymer-based material for at least one of the first substrate and the second substrate may be selected from a group consisting of BOPP, BOPET, BOPA, metallized BOPP, metallized BOPET, metallized BOPA, LDPE, LLDPE, MDPE, HDPE, and combinations thereof, the additive may comprise less than 5% of the weight of the material, the additive may reduce the period of biodegradability to between 5 and 10 years, or between 2 and 5 years, the biodegradable laminate structure may further comprise a biodegradable protective coating on an outer surface of the laminated unit, the additive may have a negligible effect on the properties of the polymer-based material, the first substrate may comprise a sealant layer, and the second layer may comprise a structural layer, and the biodegradable laminate structure may further comprise a barrier layer between the sealant layer and the structural layer.

In other aspects, the features described above may be combined together in any reasonable combination as will be recognized by those skilled in the art.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is an exploded, perspective view of a laminate film.

### DETAILED DESCRIPTION

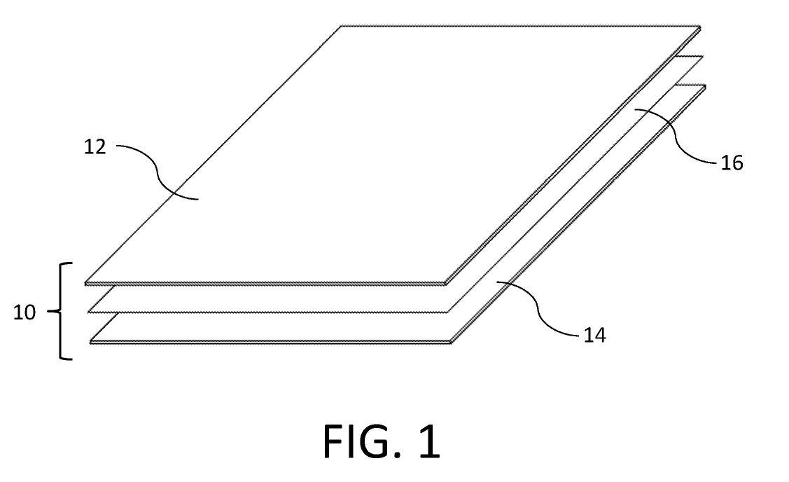

Referring to FIG. 1, there is shown a biodegradable, flexible laminate film 10. Laminate film 10 includes a first substrate 12 and second substrate 14 laminated together, as is known in the art. First and second substrates 12 and 14 may be laminated by an extrusion process, by adhesive, or by other known techniques. Each substrate is made up primarily of a polymer-based material, which will generally be a plastic derived from fossil fuels, or from biomass (sometimes referred to as bioplastic) and not readily biodegradable. Examples of suitable materials include BOPP (Biaxially Oriented Polypropylene), BoPET (Biaxially Oriented Polyethylene Terephthalate), BOPA (Biaxially Oriented PolyAmide), metallized BOPP, metallized BOPET, metallized BOPA, LDPE (Low Density Polyethylene), LLDPE (Linear Low Density Polyethylene), MDPE (Medium Density Polyethylene, HDPE (High Density Polyethylene), etc. The material selected will depend on the intended use of the laminate film, such as the type of product to be packaged, in packaging applications. It will be understood that, while laminate film 10 has at least two substrates, there may be additional substrates that are laminated to first or second layer 12/14. The number of layers, and the properties of each substrate 12/14, which may each be made from a different material, may be selected to provide the desired properties for laminate film 10. For example, there may be a sealant layer that allows packaging to be heat sealed or welded, a structural layer that supports the packaging, a barrier layer that enhances airtightness, etc. Other layers may be selected, that may be useful for packaging or for other purposes.

In order to make laminate film 10 biodegradable, an additive is added to the master batch prior to forming substrates 12/14 and laminating them together. Without the additive, the polymer-based material selected will take hundreds of years to biodegrade. In this context, the term biodegrade refers to the conditions that are present in a commercial landfill, namely, that the material will be in an anaerobic environment with microbes that break down these types of plastic. In this environment, some estimates place the time necessary for these types of plastic to biodegrade between 500 and 1000 years. The actual time will depend on many factors, but for the purposes of the discussion herein, the time period is assumed to be more than 200 years.

The additive selected may be any suitable, commercially available biodegradable plastic additive as is known in the art. The type and amount of additive will depend on the particular additive being used, and the desired characteristics. The additive is included in order to significantly reduce the period of biodegradability, such as to less than 40 years, or more preferably, to between 5 and 20 years, or even between 2 and 5 years, depending on the application required by end user. The material must maintain its integrity for the anticipated lifecycle of the product prior to discard. Preferably, the selected biodegradable additive allows microbes to break down the plastic to components that are primarily inert or organic. In one example, the plastic may break down to humus, CO2, and methane. As the material biodegrades, some other components may also be released, such as methane, carbon dioxide, etc. Preferably, the microbes that are capable of breaking down the material with the additive are those that will be commonly found in a landfill. It will also be understood that, if the material is not exposed to these microbes, the material will not break down, which may be important to consider when determining the expected lifespan of the material for any given use. As used herein, the term microbes will be understood to refer to any bacteria or other living bodies or any enzymes produced by the microbes that are capable of consuming wastes.

Preferably, the additive will have only a negligible effect on the properties of the polymer-based material that has been selected for the packaging material, such that the material performs similar to how an unmodified material would be expected to perform. In other words, the material preferably has similar properties to a non-degradable material for the intended time period over which the material is to be used. While some small change to the properties may occur, the initial material selection may be made to compensate for this. For example, to minimize the effect, the additive is preferably less than 5% of the polymer-based material by weight, while still being sufficient to permit the polymer-based material to biodegrade.

In addition to the additive, laminate film 10 may also be formed with a protective coating that may be used to protect the film for a certain period of time before breaking down, to ensure film 10 serves its intended purpose prior to degrading. Other design options may include a polyethylene resin that is made from PLA (Polylactic Acid) or PHA (Polyhydroxyalkanoates) resins.

As discussed herein, laminate film 10 may be designed and structured to offer the following environmentally friendly laminated structures:

a) a degradable laminate made from fossil fuels

b) a degradable laminate made from fossil fuels and from non fossil fuel derived resin resources

c) a degradable laminate made from fossil fuels with a high oxygen barrier

d) a degradable laminate made from fossil fuels and from non-fossil fuel derived resin resources.

It will be understood that the features described herein may be combined together in any reasonable combination as will be recognized by those skilled in the art.

In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be one and only one of the elements.

The scope of the following claims should not be limited by the preferred embodiments set forth in the examples above and in the drawings, but should be given the broadest interpretation consistent with the description as a whole.

The embodiments of the invention in which an exclusive property or privilege is claimed are defined as follows:

1. A biodegradable, flexible laminate film, comprising:
a first substrate;
a second substrate laminated to the first substrate;
wherein each substrate comprises:
a polymer-based material that is biodegradable in an anaerobic, microbial environment over a period of more than 100 years; and
an additive that reduces the period of biodegradability of the polymer-based material to less than 40 years.

2. The biodegradable film of claim 1, wherein the polymer-based material is derived from fossil fuels or biomass material.

3. The biodegradable laminate structure of claim 1, further comprising one or more additional substrates laminated to the first or the second substrate.

4. The biodegradable laminate structure of claim 1, wherein the second substrate is a different material than the first substrate.

5. The biodegradable laminate structure of claim 1, wherein adjacent substrates are connected by an adhesive or by an extrusion lamination process.

6. The biodegradable laminate structure of claim 1, wherein the polymer-based material for at least one of the first substrate and the second substrate is selected from a group consisting of BOPP, BOPET, BOPA, metallized BOPP, metallized BOPET, metallized BOPA, LDPE, LLDPE, MDPE, HDPE, and combinations thereof.

7. The biodegradable laminate structure of claim 1, wherein the additive comprises less than 5% of the weight of the material.

8. The biodegradable laminate structure of claim 1, wherein the additive reduces the period of biodegradability to between 5 and 10 years, or between 2 and 5 years.

9. The biodegradable laminate structure of claim 1, further comprising a biodegradable protective coating on an outer surface of the laminated unit.

10. The biodegradable laminate structure of claim 1, wherein the additive has a negligible effect on the properties of the polymer-based material.

11. The biodegradable laminate structure of claim 1, wherein the first substrate comprises a sealant layer, and the second layer comprises a structural layer.

12. The biodegradable laminate structure of claim 11, further comprising a barrier layer between the sealant layer and the structural layer.
